(19) United States
(12) Patent Application Publication
(10) Pub. No.: US 2014/0281036 A1
(43) Pub. Date: Sep. 18, 2014

(54) Synchronizing Scheduler Interrupts Across Multiple Computing Nodes

(71) Applicant: SILICON GRAPHICS INTERNATIONAL CORP., Fremont, CA (US)

(72) Inventors: Robert W. Cutler, Chippewa Falls, WI (US); Dimitri George Sivanich, Bloomington, MN (US)

(73) Assignee: SILICON GRAPHICS INTERNATIONAL CORP., Fremont, CA (US)

(21) Appl. No.: 13/828,896

(22) Filed: Mar. 14, 2013

(51) Int. Cl. H04L 29/08

(52) U.S. Cl. CPC H04L 29/0854
USPC 709/248

(57) ABSTRACT

A method, system and program code for synchronizing scheduler interrupts across multiple nodes of a cluster. Network timers and local scheduling timers are clocked off a system source clock. A processor in each computing node repeatedly reads a network time of day counter. The start of scheduler interrupts is synchronized when the time of day counter is at an integer multiple of a synchronizing integer number of network timer ticks. The processor sends an interprocessor scheduler interrupt to other processors in the node to synchronize scheduling timers in the computing node and throughout the cluster.

### FIELD OF THE INVENTION

The invention generally relates to scheduler synchronization and, more particularly, the invention relates to synchronizing scheduler interrupts across multiple nodes in a cluster.

### BACKGROUND OF THE INVENTION

It is well known for processors to come equipped with scheduling timers. The scheduling timer generates a periodic series of scheduling timer ticks. Each tick causes a scheduler interrupt at which time a tick interval occurs where operating system housekeeping tasks can be accomplished. It is preferable that at certain multiples of these ticks, larger housekeeping tasks needing to occur less frequently are triggered. This is considered the start of a frame of scheduling clock intervals. The scheduling timer in a number of Intel processors is known as a LAPIC timer (local advanced programmable interrupt controller).

In a computer architecture including a plurality of processors, there are situations where synchronous scheduling is advantageous. In particular, in performance critical computing with numerous processors working in parallel on a computing problem, valuable time can be wasted if some processors have taken a break for housekeeping tasks while the others are trying to work together on the problem. It is preferable that scheduler interrupts be synchronized across the multiple processors. When scheduling of larger housekeeping tasks are scheduled in frames, it is highly desirable to synchronize the frames across multiple processors. The computer system will operate more efficiently if breaks for housekeeping tasks are conducted simultaneously by the processors on the system. Achieving this synchronization becomes more challenging when the processors are in different blades or different chassis.

### SUMMARY OF VARIOUS EMBODIMENTS

In accordance with one aspect of the invention, scheduler interrupts are synchronized across multiple nodes in a cluster of computers on a local area network. In specific embodiments, the local area network is an Ethernet. A system source clock is the basis for clocking local scheduling timers and network timers in each node. In the computing node of each processor, the processor repeatedly reads the network time-of-day counter in that node. When the network time-of-day counter indicates that an integer multiple of a synchronizing integer number of network timer ticks have elapsed since a predetermined start time, the processor sends an interprocessor scheduler interrupt to the other processors in the node. The synchronizing integer corresponds to a number of network timer ticks between desired simultaneous occurrences of a network timer tick and a local scheduling timer tick. The local scheduling timers in the other processors are set upon receiving the interprocessor scheduler interrupt. By performing this process at each of the nodes in the cluster, scheduler interrupts are synchronized across the multiple nodes in the computer cluster.

In order to also synchronize scheduling frames across the cluster, the synchronizing integer is also equal to a number of network timer ticks between desired simultaneous occurrences of a network timer tick and a local scheduling timer tick at the beginning of a scheduling frame. To satisfy this condition, the synchronizing integer can equal a preset multiple of how many local scheduling timer ticks are in each scheduling frame. The number used in the threshold calculation may be determined with any number as the preset multiple. Typically, the preset multiple equals one or is set to the amount of network timer ticks in each local scheduling timer tick. In specific embodiments, the local scheduling timers are local APIC timers. For improved synchronization across multiple nodes of a cluster, the clocking of the network timers is time synchronized using a protocol, such as IEEE 1588.

In accordance with another aspect of the invention, a computing node, such as a blade, includes a network controller and a plurality of processors. The network controller includes a network timer and a time-of-day counter. Each of the processors includes a local scheduling timer. One of the processors performs the program code encoded in memory for synchronizing scheduler interrupts. The code includes instructions to repeatedly read the time-of-day counter and to generate an interprocessor scheduler interrupt when the time-of-day counter indicates that an integer multiple of a synchronizing integer number of network timer ticks have elapsed since a predetermined start time. The synchronizing integer corresponds to a number of network timer ticks between desired simultaneous occurrences of a network timer tick and a local scheduling timer tick. The synchronizing integer may also correspond to a number of network timer ticks between desired simultaneous occurrences of a network timer tick and a local scheduling timer tick at the beginning of a scheduling frame.

A computer cluster includes a plurality of these computing nodes all coupled to a local area network. The local area network is connected to a system source clock and each computing node has a network timer clocked off the system source clock. The cluster may include a plurality of chassis, each chassis having a chassis controller and each chassis controller having a network switch connected to the local area network. Each chassis contains a portion of the computing nodes.

Illustrative embodiments of the invention are implemented as a computer program product including a non-transitory computer-readable medium having the computer code thereon for synchronizing scheduling frames.

### BRIEF DESCRIPTION OF THE DRAWINGS

The foregoing features of embodiments will be more readily understood by reference to the following detailed description, taken with reference to the accompanying drawings, in which:

FIG. 1 schematically shows a computer cluster in accordance with one embodiment of the present invention;

FIG. 2 shows a flow chart of a synchronizing program for use in embodiments of the present invention; and

FIG. 3 shows two timing signals.

### DESCRIPTION OF ILLUSTRATIVE EMBODIMENTS

A computer cluster is a set of computers running their own operating systems, connected to a high speed network, and coupled so that the computers can act in coordination with one another. Computers in clusters often share data storage, e.g., using a clustered file system. A computer in the cluster can be any single system image created, without limitation, by a microprocessor, a personal computer processor, a supercomputer, a high performance computer system, or any such computer or computer system running an operating system.

The OS (operating system) software running on the computers of a cluster may include, for example, a Windows® operating system by Microsoft Corporation of Redmond, Wash., or a Linux operating system. The BIOS for such a computer may be provided as firmware by a hardware manufacturer, such as Intel Corporation of Santa Clara, Calif.

A generalized computer cluster architecture that may make use of embodiments of the present invention is shown in FIG. 1. The hardware computing nodes on the computer cluster 100 of FIG. 1 are housed within one or more chassis 110, 112, 114, 116. A chassis is an electronic chassis that is configured to house, power, and provide high-speed data communications among a plurality of computing nodes. In specific embodiments, the computing nodes are stackable, modular electronic circuit boards called blades 120, 122, 124. The modular design of a chassis permits the blades to be connected to power and data lines with a minimum of cabling and vertical space. Each blade includes enough computing hardware to act as a standalone computing server. Indeed, there may be a number of processors 190, 192, 194 running in any given blade.

Each chassis typically has a chassis management controller 130 (also referred to as a “chassis controller” or “CMC”) for managing system functions in the chassis 110 and a number of blades 120, 122, 124 for providing computing resources. Each chassis controller 130 manages the resources for just the blades in its chassis. The chassis controller 130 is physically and electrically coupled to the blades 120-124 inside the chassis 110 by means of a local management bus 138. The hardware in other chassis 112-116 may be similarly configured.

The chassis controllers communicate with each other over a local area network 150. The local area network 150 may be a high-speed LAN, for example, running an Ethernet communication protocol, or other data bus. By contrast, the blades in a chassis communicate with each other using a computing data connection 137. To that end, the computing data connection 137 illustratively has a high-bandwidth, low-latency system interconnect, such as Infiniband.

A system source clock 200 is contained in a network switch 203 on the local area network 150. The source clock 200 provides a master clock for the entire cluster. The source clock 200 may be an external clock in a top level network switch, or it may be designated on one of the chassis or computing nodes on the network 150. Any number of clock signals can be derived from the master clock. By varying the ratio of number of master clock ticks to the tick rate of the desired clock signal, a plurality of clock signals can be propagated at differing frequencies and yet based on the same master. Of significance to the embodiments of the present invention, the processors 190, 192, 194 in the computing nodes each have a local scheduling timer 210, 212, 214 run with a signal clocked off of the system source clock 200. The local scheduling timer would exhibit a local scheduling timer tick every certain number of system source clock ticks. The network clock signal would exhibit a network timer tick every certain number of system source clock ticks, which may usually differ from the frequency of local scheduling timer ticks.

Chassis 110 is shown with greater detail in FIG. 1. In this figure, parts not relevant to the immediate description have been omitted. The chassis controller 130 is shown with its connections to the local area network 150. The chassis controller 130 may be provided with a chassis data store 134 for storing chassis management data. In some embodiments, the chassis data store 134 is volatile random access memory (“RAM”). In other embodiments, the chassis data store 134 is non-volatile storage such as a hard disk drive (“HDD”) or a solid state drive (“SSD”).

Whereas clusters may be formed with computing nodes connected directly to the local area network 150, in the embodiment shown the computing nodes are all housed in chassis. To service such an architecture, chassis controller 130 includes a network switch 330. In specific embodiments of the invention, the local area network 150 supports the Ethernet protocol and the network switch 330 is an Ethernet switch. The network switch includes one or more physical layer transceivers (PHY) 332 that connect to the local area network 150. The PHY transmits and receives network packets and also provides a clock signal recovered from the receive path from local area network 150. The recovered clock signal from the PHY 332 is distributed to all of the computing nodes in the chassis 110. Preferably, the clock signal from the PHY is fed through a clean-up phase locked loop to provide a clean clock signal for use as the root of all clock signals in the computing nodes. By basing the clock signals in the processors 190, 192, 194 and the clock signals on the LAN 150 on the source clock 200, frequency synchronization is achieved.

The network switch 330 is also responsible for distributing time of day to all of the computing nodes in the chassis 110. In some embodiments, the network switch relies upon a transparent clock functionality.

One unique example of an alternate system and method for deriving a synchronous local clock signal from a system source clock is disclosed in copending application docket number 3549/123, U.S. Ser. No. 13/798,604, filed Mar. 13, 2013, entitled “Global Synchronous Clock” and assigned to the same assignee as the present application. The full disclosure of this copending application is hereby incorporated by reference herein. In this alternative method for recovering the synchronous clock signal locally, a physical layer transceiver (“PHY”) is provided in each of the computing nodes 120, 122, 124.

FIG. 1 shows relevant portions of a specific implementation of blade 120. The other blades may be similarly constructed. The blade 120 includes a blade management controller 160 (also called a “blade controller” or “BMC”) that executes system management functions at a blade level, in a manner analogous to the functions performed by the chassis controller at the chassis level. In addition, the blade controller 160 may have its own RAM 162 to carry out its management functions. The chassis controller 130 communicates with the blade controller of each blade using the local management bus 138.

The blade 120 also includes one or more processor chips 170, 172 that are connected to RAM 182, 184. Blade 120 may be alternately configured so that multiple processor chips may access a common set of RAM on a single bus, as is known in the art. The processor chips 170, 172 are connected to other items, such as a data bus that communicates with I/O devices 188, a data bus that communicates with non-volatile storage 186, and other buses commonly found in standalone computing systems. (For clarity, FIG. 1 shows only the connections from processor 170 to these other devices.) The processor chips 170, 172 may be, for example, Intel® Core™ processor chips manufactured by Intel Corporation. The I/O bus may be, for example, a PCI or PCI Express (“PCIe”) bus. The storage bus may be, for example, a SATA, SCSI, or Fibre Channel bus. It will be appreciated that other bus standards, processor types, and processor manufacturers may be used in accordance with illustrative embodiments of the present invention.

It should also be appreciated that processor chips 170, 172 may include any number of processors 190, 192, 194 such as central processing units (“CPUs”) or cores, as is known in the art. Each processor 190, 192, 194 is associated with a local scheduling timer 210, 212, 214. In specific embodiments, the local scheduling timers may be LAPIC timers. The scheduling timer issues an interrupt at every scheduling timer tick to trigger operating system housekeeping tasks. The processors in the cluster may also be programmed to recognize major scheduling frames every certain number of scheduling timer ticks. The number of scheduling timer ticks in a frame is made known throughout the cluster. At the beginning of each frame of processing, larger housekeeping tasks may take place in the processors thoughout the cluster. Since the processors on a cluster are only loosely coupled, the scheduling timer ticks issued in each local scheduling timer are not synchronized without performing a synchronization. A method for synchronizing the scheduling timer ticks will be described below with regard to FIG. 2.

In order to enhance the accuracy of time synchronization of scheduling timer ticks, in accordance with embodiments of the invention, time synchronization is provided for the clock signal used on the LAN 150. In specific embodiments, precision time protocol is used to synchronize clocks throughout the local area network 150. One particular protocol is known as IEEE 1588. Thus, the network controller 230 selected for use in each computing node, according to such an embodiment, supports the IEEE 1588 protocol. This is a protocol that uses time stamps to identify latencies in the network and then compensates for any such latencies. Thus, a time of day can be provided to all computing nodes so that they all have simultaneous and synchronous time of day. Each network controller 230 includes a time of day counter 234 and a clock timer 232. The network controllers 230 that support IEEE 1588 include time stamping capability. The source clock 200 periodically sends IEEE 1588 SYNC packets on the LAN 150. Network switches along the way are transparent clocks which account for the variable propagation delay of the IEEE 1588 packets through the switch. Preferably, this is a one-step grand master source clock that places the current time in the IEEE 1588 SYNC packet as it leaves the switch and one-step transparent clocks that adjust the IEEE 1588 SYNC packet time field as it flows through the switch. The network controllers 230 in the computing nodes act as ordinary slave clocks as they receive the IEEE 1588 SYNC packets and use them to synchronize their local time of day counters 234. Thus, the IEEE 1588 protocol synchronizes the time of day counters in all of the computing nodes in the cluster.

In accordance with aspects of the present invention, the network timing is used by a processor in each computing node to synchronize the timing of the local scheduling timers. The synchronization method shall now be described with reference to FIG. 2. As explained with regard to the cluster architecture, clock signals in the processors of the computing nodes are derived from a system source clock 200. Thus, the local processor timers, and hence the local scheduling timers, are clocked 402 off the system source clock. This provides frequency synchronization across computing nodes. Network timers are also clocked 404 off the system source clock. In a large cluster, time delays across the local area network 150 may result in time variations across multiple nodes on the cluster. To overcome such issues, it is desirable to also time synchronize the network clock signal across the cluster. In accordance with a specific embodiment, time synchronization may be achieved by implementation of IEEE 1588 on the local area network 150. The synchronization of network timing in frequency and time is reflected in the time of day counters 234 in all of the computing nodes.

Program code is written into a non-transitory computer-readable medium, such as processor memory, for synchronizing the scheduling timer ticks. The code is performed upon starting up a cluster or joining a cluster. In specific embodiments, the code is made part of the Linux kernel. At least one processor in each computing node 120 performs the code. The processor is instructed to read 406 the network time of day counter 234 in the computing node. The processor determines 408 whether the time of day indicates an integer multiple of a synchronizing integer number of network timer ticks have elapsed since a predetermined start time. Typically the start time will be time zero, but another agreed start time may be used instead. The synchronizing integer corresponds to a number n of network timer ticks in an interval between simultaneous occurrences of a network timer tick and a local scheduling timer tick when the desired synchronization has been achieved. If in FIG. 3, signal A is the desired network timing signal and signal B is the local scheduling timer signal, then the number 6 could be used as the synchronizing integer, since every 6 network timer ticks, the network timer tick coincides with the scheduling timer tick. This was a simple example where all of the ticks in signal B occur simultaneously with a tick in signal A. Mathematically, one could determine a synchronizing integer by dividing the size of a scheduling tick interval by the size of a network tick interval and multiplying by an integer which results in an integer. For example, when there are 6 network ticks per scheduling tick 6/1 times 1 equals 6. If there are 5 network ticks per every 17 scheduling ticks, then each scheduling tick interval is 5/17 the size of a network tick. Multiplying by the integer 17 produces the integer 5 which can be used as the synchronizing integer.

It is further desirable to synchronize scheduling frames across the multiple nodes of the cluster. To achieve this objective, the synchronizing integer n used to compare with the time of day counter should also equal a number of network timer ticks between desired simultaneous occurrences of a network timer tick and a local scheduling timer tick at the beginning of a scheduling frame. Typically, a preset multiple of the number of local scheduling timer ticks in each scheduling frame will satisfy this requirement. A synchronizing integer that satisfies this requirement will necessarily satisfy the first requirement for synchronizing scheduler interrupts. To better understand the synchronizing integer used in the time of day counter comparison 408, we refer to FIG. 3. Assume that the clock signal A is the local scheduling timer clock signal and the clock signal B is the network clock. Note that both are frequency synchronized as they are both derived from the same source clock. The synchronizing integer is predetermined to set all of the scheduling timers in a processing node to synchronously produce scheduling ticks and for the processors in the node to start scheduling frames on the same clock tick used in all the nodes on the cluster. For illustration purposes, we assume that the cluster has set the length of a scheduling frame at 13 local clock ticks. If a tick on the local scheduling timer clock signal A and a tick on the clock signal B both coincide with the start of a scheduling frame, the next time ticks on both signals will coincide with the start of a scheduling frame will be 13 ticks later on the network clock. Indeed, every thirteen ticks on the network clock there will be a new scheduling frame. Since all nodes on the cluster have access to read a time of day counter, frame scheduling may begin for any node when the time of day counter is at an integer multiple of 13 network timer ticks have elapsed since a predetermined start time. In this example, each scheduling interval is ⅙ the size of a network timer interval multiplied by 6 equals 1. So a synchronizing integer of 1 or indeed any multiple of 1 can be used as the synchronizing integer in this example for scheduler interrupt synchronization. To achieve frame synchronization, the integer needs to be a preset multiple of 13. Thus the synchronizing integer may be 13, 26, 39, . . .

By using IEEE 1588 to time synchronize the time of day counters even better synchronization of scheduling frames across the cluster is achieved. The program only needs to be run once upon joining the cluster to synchronize the scheduling ticks and frames for a computing node. If desired the program code can be run diagnostically to make sure there has been no divergence from the synchronized schedule for initiating scheduling frames. If a problem is detected, the program can be run to resynchronize the scheduling frames.

Now assume the network has a faster clock than the local scheduling timer. In this example, clock signal A is the network clock and the clock signal B is the local scheduling timer clock signal. When this example was discussed above, the synchronizing integer was determined to be a multiple of 6 because every 6 network timer ticks the network timer tick coincides with a local scheduling timer tick. For an illustration of frame synchronization, we assume that the cluster has set the length of a scheduling frame at 13 local clock ticks in signal B. If a tick on the local scheduling timer clock signal B and a tick on the network clock signal A both coincide with the start of a scheduling frame, the next time ticks on both signals will coincide with the start of a scheduling frame will be 78 ticks later on the network clock A. Indeed, every 78 ticks on the network clock there will be a start of a new scheduling frame. The synchronizing integer must be a multiple of 6 to achieve scheduling tick synchronization and a multiple of 13 to achieve frame synchronization. 6 times 13 equals 78. So the synchronizing integer in this example can be 78, 156, 234 . . . to satisfy the requirements for scheduler interrupt synchronization and frame synchronization. Since all nodes on the cluster have access to read a time of day counter, frame scheduling may begin for any node when the time of day counter is an integer multiple of 78.

If the time of day counter does not indicate an integer multiple of the synchronizing integer has elapsed since the predetermined start time, the processor repeats the read of the time of day counter. A start time of time zero is shown in FIG. 2. The counter is repeatedly read until an integer multiple of the synchronizing integer has elapsed. Upon detecting a time of day corresponding to an integer multiple of the synchronizing integer beyond the start time, the processor sends 410 an interprocessor scheduler interrupt to the other processors in the computing node. This will synchronize the scheduling timers and, if frame synchronization is being used, will indicate to the processors the beginning of a frame. Upon receiving the interprocessor scheduler interrupt each of the local scheduling timers is set to properly time its scheduling ticks and hence the scheduler interrupts associated with each of the scheduling ticks. A scheduling timer sends a scheduler interrupt to its associated processor at each scheduling tick. The processors will thereafter count from the start of a frame the local scheduler interrupts per frame. When the count indicates a next frame starts, the processor will begin the major housekeeping tasks in unison with all the other processors on the cluster.

By synchronizing the local scheduling timers from the network time of day counter, the scheduling timer ticks and the scheduling frames in all processors on the computing node can be set to start synchronously. By time synchronizing the network timers in the cluster, the scheduling timer ticks and frames for all processors across the multiple nodes on the cluster are synchronized to begin at the same time. By synchronizing the scheduling frames across the cluster, the cluster more efficiently attends to performance critical computing tasks.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium.

The medium may be either a tangible medium (e.g., optical or analog communications lines) or a medium implemented with wireless techniques (e.g., WIFI, microwave, infrared or other transmission techniques). The series of computer instructions can embody all or part of the functionality previously described herein with respect to the system. The process of FIG. 2 is merely exemplary and it is understood that various alternatives, mathematical equivalents, or derivations thereof fall within the scope of the present invention.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method for synchronizing scheduler interrupts across multiple nodes in a cluster of computers on a local area network, the method comprising:
clocking local scheduling timers in each of the nodes in the cluster off a system source clock;
clocking network timers in each node off the system source clock;
a processor in each node repeatedly reading a network time-of-day counter in the node of the processor; and
the processor in each node sending an interprocessor scheduler interrupt to at least one other processor in the node of the processor when the network time-of-day counter in the node of the respective processor indicates that an integer multiple of a synchronizing integer number of network timer ticks have elapsed since a predetermined start time, wherein the synchronizing integer corresponds to a number of network timer ticks between desired simultaneous occurrences of a network timer tick and a local scheduling timer tick, such that the local scheduling timer ticks are synchronized across the processors in the multiple nodes in the computer cluster.

2. The method of claim 1, wherein the synchronizing integer also equals a number of network timer ticks between desired simultaneous occurrences of a network timer tick and a local scheduling timer tick at the beginning of a scheduling frame, so that scheduling frames are synchronized across the processors in the multiple nodes in the computer cluster.

3. The method of claim 2, wherein the synchronizing integer equals a preset multiple of how many local scheduling timer ticks are in each scheduling frame.

4. The method of claim 3, wherein the preset multiple equals one.

5. The method of claim 3, wherein the preset multiple equals how many network timer ticks are in each local scheduling timer tick.

6. The method of claim 1, wherein the local scheduling timers are local APIC timers.

7. The method of claim 1, further comprising synchronizing the network time of day counters.

8. The method of claim 7, wherein synchronizing is conducted in accordance with IEEE 1588.

9. The method of claim 1, wherein the local area network is an Ethernet network.

10. The method of claim 1, further comprising setting the local scheduling timers in the at least one other processors upon receiving the interprocesor scheduler interrupt.

11. A computing node comprising:
a network controller having a network timer and a time-of-day counter;
a plurality of processors, each processor having a local scheduling timer; and
a memory encoded with instructions, wherein execution of the instructions by one of the processors causes the processor:
to repeatedly read the time-of-day counter; and
to generate an interprocessor scheduler interrupt when the time-of-day counter indicates that an integer multiple of a synchronizing integer number of network timer ticks have elapsed since a predetermined start time, wherein the synchronizing integer corresponds to a number of network timer ticks between desired simultaneous occurrences of a network timer tick and a local scheduling timer tick.

12. The method of claim 11, wherein the synchronizing integer also equals a number of network timer ticks between desired simultaneous occurrences of a network timer tick and a local scheduling timer tick at the beginning of a scheduling frame.

13. The computing node of claim 12, wherein the synchronizing integer equals a preset multiple of how many local scheduling timer ticks are in each scheduling frame.

14. The computing node of claim 13, wherein the preset multiple equals one.

15. The computing node of claim 13, wherein the preset multiple equals how many network timer ticks are in each local scheduling timer tick.

16. The computing node of claim 11, wherein the local scheduling timer is a local APIC timer.

17. The computing node of claim 11, wherein the network timer operates according to IEEE 1588.

18. The computing node of claim 11, wherein the network controller comprises an Ethernet controller.

19. A computer cluster comprising:
a local area network;
a system source clock;
a plurality of computing nodes, each computing node having a network controller connected to the local area network, and each network controller having a network timer clocked off the system source clock and a time-of-day counter;
a plurality of processors in each computing node, each processor having a local scheduling timer clocked off the system source clock; and
a memory, in each computing node, encoded with instructions, wherein execution of the instructions by one of the processors in the computing node causes the processor:
to repeatedly read the time-of-day counter; and
to generate an interprocessor scheduler interrupt when the time-of-day counter indicates that an integer multiple of a synchronizing integer number of network timer ticks have elapsed since a predetermined start time, wherein the synchronizing integer corresponds to a number of network timer ticks between desired simultaneous occurrences of a network timer tick and a local scheduling timer tick.

20. The computer cluster of claim 19, wherein the synchronizing integer also equals a number of network timer ticks between desired simultaneous occurrences of a network timer tick and a local scheduling timer tick at the beginning of a scheduling frame.

21. The computer cluster of claim 20, wherein the synchronizing integer equals a preset multiple of how many local scheduling timer ticks are in each scheduling frame.

22. The computer cluster of claim 21, wherein the preset multiple equals one.

23. The computer cluster of claim 21, wherein the preset multiple equals how many network timer ticks are in each local scheduling timer tick.

24. The computer cluster of claim 19, wherein the local scheduling timer of each processor is a local APIC timer.

25. The computer cluster of claim 19, wherein the time of day counters in the plurality of computing nodes are synchronized according to IEEE 1588.

26. The computer cluster of claim 19, wherein the network controller of each computing node comprises an Ethernet controller.

27. The computer cluster of claim 19, comprising a plurality of chassis, each chassis having a chassis controller with a network controller connected to the local area network, and wherein each chassis includes a portion of the plurality of computing nodes.

28. A computer program product including a non-transitory computer-readable medium having computer code thereon for synchronizing scheduling frames across a plurality of computing nodes each clocking local scheduling timer ticks off a source clock on a network, the computer code comprising:
program code for repeatedly reading a time-of-day counter in a network controller, wherein the time-of-day counter is clocked off the source clock; and
program code for generating an interprocessor scheduler interrupt when the time-of-day counter indicates that an integer multiple of a synchronizing integer number of network timer ticks have elapsed since a predetermined start time, wherein the synchronizing integer corresponds to a number of network timer ticks between desired simultaneous occurrences of a network timer tick and a local scheduling timer tick is at an integer multiple of a number, wherein the number corresponds to a preset multiple of how many local scheduling timer ticks are in each scheduling frame.

29. The computer program product of claim 28, wherein the synchronizing integer also equals a number of network timer ticks between desired simultaneous occurrences of a network timer tick and a local scheduling timer tick at the beginning of a scheduling frame.

30. The computer program product of claim 29, wherein the synchronizing integer equals a preset multiple of how many local scheduling timer ticks are in each scheduling frame

31. The computer program product of claim 30, wherein the preset multiple equals one.

32. The computer program product of claim 30, wherein the preset multiple corresponds to how many network timer ticks are in each local scheduling timer tick.
